(19) United States
(12) Patent Application Publication
(10) Pub. No.: US 2009/0033022 A1
(43) Pub. Date: Feb. 5, 2009

(54) Paper feed roller and fabrication method thereof

(76) Inventors: Takashi Iki, Kyoto-shi (JP); Kazuhiro Oosaki, Kyoto-shi (JP)

Correspondence Address: JORDAN AND HAMBURG LLP, 122 EAST 42ND STREET, SUITE 4000, NEW YORK, NY, 10168, US

(21) Appl. No.: 10/518,986

(22) PCT Filed: Oct. 28, 2002
(86) PCT No.: PCT/JP02/11181

§ 371 Date: Dec. 21, 2004

(30) Foreign Application Priority Data
Jul. 10, 2002 (JP) 2002-200693

(51) Int. Cl. B65H 5/06; B05D 7/00; B32B 37/02

(52) U.S. Cl. 271/109; 427/407.1; 156/153

(57) ABSTRACT

A paper feed roller which can secure rigidity and precision and can cut the machining cost and material cost, as well as a fabrication method thereof are provided.

A paper feed roller (10) comprises a hollow pipe member (11) forming a paper feed portion for feeding paper, and a pair of shaft members (12) fastened concentrically on to both end portions of the pipe member (11). The pipe member (11) comprises a hollow steel pipe (13), a synthetic resin coating layer (14) for covering an outer surface of the steel pipe (13), and a synthetic resin friction coating layer (18) containing hard particles (16) formed on an outer surface of the coating layer (14). A steel pipe (for example, an artificial bamboo) covered with a synthetic resin coating layer is applicable as material of the pipe member (11), and after fastening the shaft members (12) on to the both ends of this material, a part of the outer surfaces of the shaft members (12) and an entire outer surface of the coating layer (14) are machined smoothly, and then the synthetic resin friction coating layer (18) is formed.

### TECHNICAL FIELD

The present invention relates to a paper feed roller for office automation equipment, such as a printer, facsimile and copier, and to a fabrication method thereof.

### BACKGROUND OF THE INVENTION

Conventionally, in office automation equipment such as a printer, facsimile, and copier, a paper feed roller for feeding paper is obtained by integrally forming a paper feed portion for feeding paper and the pair of shaft portions at both ends thereof, where a friction coating layer made from a synthetic resin containing hard particles generally is formed on an outer surface of the paper feed portion.

When fabricating this paper feed roller, it can be fabricated by machining a steel rod material to form shaft portions on both end portions thereof, to form a plate coating the outer surface of the shaft portion, and to form the synthetic resin friction coating layer on the outer surface of the paper feed portion.

Incidentally, there is known a technology in which a mixture of hard particles and an adhesive is screen-printed, in dots or in a linear form, onto an outer surface of a pipe member of a paper feed roller, after which the adhesive is cured to form a large number of projections, and also a technology in which a mixture of hard particles and a UV curing type adhesive is applied to an entire outer surface of a pipe member of a paper feed roller, after which ultraviolet radiation is irradiated, in dots or in a linear form, onto this mixture to partially cure the UV curing type adhesive, with uncured portion of the LW curing type adhesive being removed, to form a large number of projections (Japanese Patent Laid-Open Publication No. H9-30702).

Further, there is known a technology in which a LW curing type resin film having hard particles dispersed therein beforehand is coated on a surface of a metal bar, onto which ultraviolet radiation is irradiated to cure the LW curing type resin film (Japanese Patent Laid-Open Publication No. H11-208921).

Problems to be solved by the present invention will now be described.

Recently, as the prices of office automation equipment and the like are being reduced, reduction of cost in each part is requested. However, when fabricating a paper feed roller to have the above-described structure to fabricate it in such a way as described above, not only that a heavy paper feed roller is obtained, but also that the material cost, machining cost and the cost of plate processing will be expensive, thereby raising the fabrication cost of the paper feed roller.

Therefore, in order to cut the material cost, a paper feed roller made of a steel pipe member as a material is also practiced. However, for the pipe member, an outer surface thereof needs to be machined and shaft members for fastening a gear or the like have to be provided on both end portions, because the linear precision of the material is low, thus this paper feed roller is more disadvantageous in terms of quality and the fabrication cost than the paper feed roller fabricated from the above-described solid steel material.

On the other hand, although a paper feed roller, the entirety of which is made from a synthetic resin, is also practiced, it lacks rigidity, has low linear precision, and has a problem that, when the temperature rises during use, it expands thermally, thus it is difficult to realize a paper feed roller of high quality.

Meanwhile, in a paper feed roller in which a large number of hard particles are mixed with an organic solvent coating composition and this mixture is applied to an outer surface of a pipe member to form a friction coating layer, an excessive number of hard particles are deposited in the coating composition, thereby increasing the friction coefficient of the friction coating layer, which makes it difficult to improve feed performance of the paper feed roller. Moreover, in order to cure (dry) the coating composition, if heating up the coating composition and pipe member to reach a high temperature (for example, around 150 degrees), heat deformation (thermal expansion) occurs on the pipe member, whereby a paper feed roller can not be fabricated with accuracy.

Therefore, Japanese Patent Laid-Open Publication No. H9-30702 and Japanese Patent Laid-Open Publication No. H11-208921 disclose a method of fabricating a paper feed roller in which a UV curing type adhesive or UV cured resin sheet alternative to the above coating composition is used. However, it is difficult to create a UV curing type adhesive or UV cured resin sheet that contains a large number of hard particles substantially equally, and also, as described above, an excessive number of hard particles are likely to be deposited in the UV curing type adhesive or UV cured resin sheet, thus it is difficult to increase the friction coefficient of the friction coating layer.

An object of the present invention is to provide a paper feed roller which can be produced inexpensively, is lightweight, can secure a linear precision, and can improve paper feed performance, and a fabrication method thereof. A further object of the present invention can be understood from the descriptions of the effect and of embodiments of the present invention.

### DISCLOSURE OF THE INVENTION

The paper feed roller of the present invention comprises a hollow pipe member forming a paper feed portion for feeding paper, and a pair of shaft members fastened concentrically on to both end portions of this pipe member in the paper feed roller for feeding paper, wherein the pipe member comprises a steel pipe, a coating layer made from a synthetic resin for covering an outer surface of this steel pipe, and a synthetic resin friction coating layer containing hard particles formed on the outer surface of this coating layer.

This paper feed roller has a hollow pipe member forming a paper feed portion, and a pair of shaft members fastened concentrically on to both end portions of this pipe member. In a state where the paper feed roller is mounted in office automation equipment, both ends of the shaft members are pivoted by a machine casing of the office automation equipment, a gear is fixed to at least one of the shaft members, and a rotary drive force is inputted from a drive mechanism. Note that the shaft members may be made from metal or a synthetic resin.

The pipe member comprises a steel pipe, a coating layer made from a synthetic resin for covering an outer surface of the steel pipe, and a synthetic resin friction coating layer containing hard particles formed on an outer surface of the coating layer. Therefore, for the material of the pipe member, an extremely inexpensive artificial bamboo for gardening, which has a structure where the outer surface of a steel pipe with a wall thickness of approximately 0.25 to 0.40 mm (e.g. a steel pipe where a strip-shaped hoop is formed into the shape of a pipe and a joint line is welded) is covered with a synthetic resin coating layer, can be employed. Thus, the material cost of the pipe member can be reduced.

In particular, since this paper feed roller has the pair of shaft members fastened concentrically on to the both end portions of the hollow pipe member forming the paper feed portion, a steel pipe with a small wall thickness can be applied as the steel pipe for the pipe member.

This pipe member is lightweight while being able to secure rigidity by means of the steel pipe, and further has the synthetic resin coating layer which is softer than the steel on an inner layer of the friction coating layer, thus paper easily sticks to the pipe member when being fed, which provides excellent paper feed performance. Further, the steel pipe is covered with the coating layer, thus is rustproofed.

In a fabrication stage of this pipe member, when its outer surface is machined smoothly, it is only necessary to machine the outer surface of the synthetic resin coating layer. Hence, not only that the machining cost can be reduced dramatically, but also that linear precision and precision of the cylindrical surface can be secured, and that the synthetic resin friction coating layer easily sticks to the coating layer, whereby the friction coating layer can be formed readily. Consequently a paper feed roller, which can be fabricated inexpensively, is lightweight, and secures precision, can be obtained.

Moreover, another paper feed roller for feeding paper according to the present invention comprises a hollow pipe member forming a paper feed portion for feeding paper, wherein the pipe member comprises a steel pipe, a coating layer made from a synthetic resin for covering an outer surface of the steel pipe, and a synthetic resin friction coating layer containing hard particles formed on the outer surface of the coating layer.

The pipe member of this paper feed roller is same as the pipe member of the paper feed roller which is described hereinabove, and achieves the same operation and advantages as those of the abovementioned pipe member.

In this paper feed roller, shaft members are formed by utilizing extended portions that are portions at both ends of the pipe member and that extend in both sides of the paper feed portion. In each shaft member, the coating layer is removed, and gear teeth are formed on the steel pipe of the shaft member through a forming process, a shaft portion to be supported by a bearing member is formed, and a shaft portion onto which a gear member can be fastened is formed. Therefore, the steel pipe is to have a wall thickness (0.4 to 1.0 mm, for example) that is thicker than the wall thickness of the steel pipe described in claim 1.

However, when forming the shaft portions consisting of the pipe member itself in the both end portions of the pipe member, although it is necessary to make the wall thickness of the steel pipe of the pipe member bigger than that of the steel pipe described in claim 1, the fabrication cost can be reduced, since the number of parts can be reduced.

Now, preferred constitutions regarding the configuration of above two inventions will be described.

a) The outer surface of the coating layer is machined smoothly, and then the synthetic resin friction coating layer is formed on the outer surface of the coating layer. Therefore, by simply forming the outer surface of the coating layer into a cylindrical surface of high precision, followed by forming the friction coating layer, a paper feed roller of high linear precision and high precision of the cylindrical surface can be obtained.

b) The pipe member is fabricated using the steel pipe covered with the coating layer as material. Therefore, since this paper feed roller can be fabricated out of a commercially available resin coating steel pipe (for example, an artificial bamboo for gardening, or the like), the material cost can be reduced remarkably.

Furthermore, the fabrication method of a paper feed roller according to the present invention comprises; a first step in which a steel pipe covered with a synthetic resin coating layer is prepared as material for a hollow pipe member forming a paper feed portion for feeding paper, and a pair of shaft members to be fastened on to both end portions of the pipe member are prepared; a second step in which the pair of shaft members are fastened on to the both end portions of the steel pipe covered with the coating layer, and then at least a part of the outer surfaces of the shaft members and the entire outer surface of the coating layer are machined smoothly; and a third step in which a synthetic resin friction coating layer containing hard particles is formed on the outer surface of the coating layer.

In the fabrication method of this paper feed roller, in the first step the steel pipe covered with the synthetic resin coating layer is prepared, and also the pair of shaft members to be fastened on to both end portions of the pipe member are prepared. Then in the second step, the pair of shaft members are fastened on to the both end portions of the steel pipe covered with the coating layer, after which at least a part of the outer surfaces of the shaft members and the entire outer surface of the coating layer are machined smoothly. Next, in the third step, the synthetic resin friction coating layer containing hard particles is formed on the outer surface of the coating layer. Consequently, a paper feed roller, which is basically same as the paper feed roller described hereinabove and which achieves the same operation and advantages, can be fabricated inexpensively.

Moreover, another fabrication method of a paper feed roller according to the present invention comprises; a preparation step in which a steel pipe covered with a synthetic resin coating layer is prepared as material for a hollow pipe member forming a paper feed portion for feeding paper; a machining step in which the entire outer surface of the coating layer is machined smoothly; an adhesive application step for applying a UV curing type adhesive on the outer surface of the coating layer; a particle adhering step in which a large number of hard particles are dispersed in and adhered substantially evenly to the UV curing type adhesive adhered to the outer surface of the coating layer; and an adhesive curing step in which the UV curing type adhesive having the hard particles adhered thereto is irradiated with ultraviolet radiation to cure the UV curing type adhesive, whereby a synthetic resin friction coating layer containing the hard particles is formed on the outer surface of the coating layer.

In this fabrication method of a paper feed roller, in the preparation step a steel pipe covered with the synthetic resin coating layer is prepared, and then, in the machining step, the entire outer surface of the coating layer is machined smoothly. Thereafter, in the adhesive application step, the UV curing type adhesive is applied on the outer surface of the coating layer which is machined smoothly, and then, in the particle adhering step a large number of hard particles are dispersed in and adhered substantially evenly to the UV curing type adhesive adhered to the outer surface of the coating layer. In this case, a large number of hard particles may be adhered to the UV curing type adhesive by spraying or dusting them. The UV curing type adhesive having the hard particles adhered thereto is then irradiated with ultraviolet radiation to cure the UV curing type adhesive, whereby the synthetic resin friction coating layer containing hard particles is formed on the outer surface of the coating layer.

As to the UV curing type adhesive, an acrylic adhesive, polyurethane adhesive, silicon adhesive, or epoxy adhesive of UV curing type is put to use. When applying the UV curing type adhesive on the outer surface of the coating layer, it may be applied using a brush or roller, or alternatively a spin-coating technique is put to use.

It is preferred that the film thickness of the UV curing type adhesive applied on the outer surface of the coating layer be, for example, 30 to 35 μm, and that the particle diameter of the hard particles adhered to the UV curing type adhesive be, for example, 30 to 60 μm.

According to this fabrication method of a paper feed roller, after applying the UV curing type adhesive to the outer surface of the coating layer covering the steel pipe, a large number of hard particles can be dispersed in and adhered substantially evenly to this UV curing type adhesive. Consequently, while the UV curing type adhesive appropriately contains a large number of hard particles, the hard particles are caused to be exposed to the surface side of the UV curing type adhesive relatively significantly, in which state ultraviolet radiation is applied to the UV curing type adhesive to cure the UV curing type adhesive, whereby a large number of hard particles can be securely fixed to the UV curing type adhesive. Therefore, the friction coefficient of the synthetic resin friction coating layer containing the hard particles dramatically becomes large, thus a paper feed roller of high paper feed performance can be fabricated.

Furthermore, by irradiating the UV curing type adhesive with ultraviolet radiation, the UV curing type adhesive can be cured readily, thus the amount of time taken for an adhesive curing step can be shortened, whereby efficiency of the paper feed roller fabrication can be increased. Moreover, because there is no need to raise the temperatures of the steel pipe, coating layer and the like in order to cure (dry) the UV curing type adhesive, heat deformation (thermal expansion) can be prevented, and the paper feed roller can be fabricated precisely.

In addition, the material cost of the UV curing type adhesive becomes more inexpensive than the coating composition that has always been used. As with above fabrication method of a paper feed roller, an extremely inexpensive artificial bamboo for gardening, which has a structure where the steel pipe is covered with the coating layer, can be employed as the material of the hollow pipe member that forms the paper feed portion for feeding paper, thus the fabrication cost of the paper feed roller can be reduced dramatically.

Preferred constitutions regarding the above-described configuration of above two inventions will now be described.

a) The pair of shaft members to be fastened to both end portions of the pipe member are prepared in the abovementioned preparation step, and after fastening the pair of shaft members on to the both end portions of the steel pipe, in the machining step the entire outer surface of the coating layer is machined. Therefore, by supporting the pair of shaft members and rotating the steel pipe, the entire outer surface of the coating layer can be machined smoothly.

b) In the machining step, a part of the outer surfaces of the shaft members fastened on to the steel pipe are machined smoothly. Therefore, the outer surface of the coating layer together with a part of the outer surfaces of the pair of the shaft members can be machined smoothly and integrally.

### BRIEF DESCRIPTION OF THE DRAWINGS

FIG. 1 is a perspective view of a printer related to the embodiments of the present invention.

FIG. 2 is a plan view of a paper feed roller.

FIG. 3 is a sectional view along III-III of FIG. 2.

FIG. 4 is a front elevational view of the paper feed roller (before installing the shaft members) at the mid-stage of the fabrication process.

FIG. 5 is an enlarged sectional view of an essential part of the pipe member.

FIG. 6 is a front elevational view of the paper feed roller (after installing the shaft members) at the mid-stage of the fabrication process.

FIG. 7 is an enlarged sectional view of a portion of an end side of the paper feed roller.

FIG. 8 is a plan view of the paper feed roller related to a modified embodiment.

FIG. 9 is an enlarged sectional view of the end side portion of the paper feed roller of FIG. 7.

FIG. 10 is a sectional view of an essential part of the paper feed roller related to an another embodiment.

FIG. 11 is a process diagram of the fabrication method of the paper feed roller related to the another embodiment.

### PREFERRED EMBODIMENT OF THE INVENTION

The best mode for implementing the present invention will now be described.

The present embodiment is an example of a case where the present invention is applied to a paper feed roller for feeding paper in an inkjet printer, and to a method of fabricating the paper feed roller.

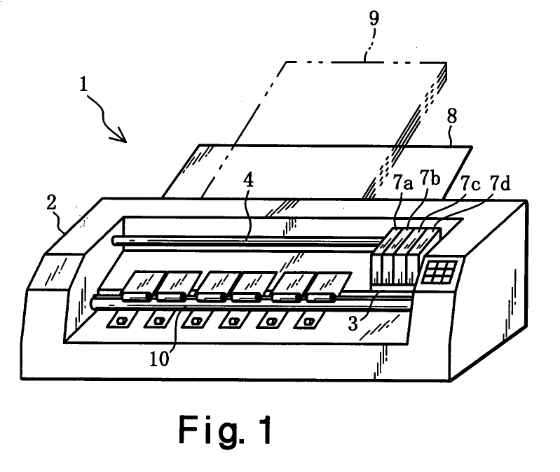

As shown in FIG. 1, a printer 1 is an inkjet printer, where a space for movement of a carriage 3 is provided in a top face side portion of a main body case 2, the carriage 3 being guided and supported by a carriage guide shaft 4 so as to be able to reciprocate from side to side, and the carriage 3 also being driven and moved by a stepping motor through a timing belt, both ends of which are coupled to the carriage 3, and a pair of pulleys. Ink cassettes of, for example, four colors of 7a to 7d are detachably installed in the carriage 3. Paper 9 is fed from a tray 8, and fed by a paper feed roller 10 and press roller on top thereof, and then printing is performed by the print head of the carriage reciprocating with respect to this paper.

Next, the structure of the paper feed roller 10 will be described.

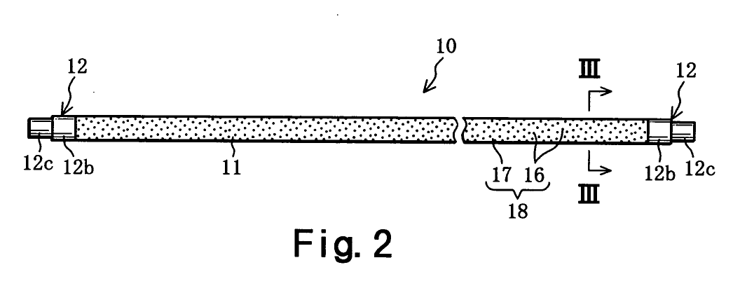

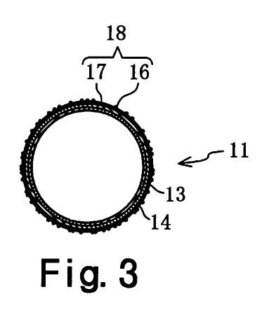

As shown in FIG. 2 and FIG. 3, the paper feed roller 10 comprises a hollow pipe member 11 forming a paper feed portion for feeding paper, and a pair of shaft members 12 fastened concentrically on to both end portions of this pipe member 11. The pipe member 11 comprises a steel pipe 13, a coating layer 14 made from a synthetic resin (ABS resin or the like) for covering an entire outer surface of this steel pipe, and a synthetic resin friction coating layer 18 containing hard particles 16 formed on an outer surface of this coating layer 14.

The steel pipe 13 has, for example, a diameter of approximately 1.0 cm and a wall thickness of approximately 0.25 cm, and is a seamed steel pipe where a joint line is welded while forming a strip-shaped hoop into the shape of a pipe. However, all elements of the pipe member 13 are merely an example, and the steel pipe may be a seamless pipe.

The coating layer 14 is applied by means of extrusion molding so as to cover an entire outer surface of the steel pipe 13, and has a wall thickness of, for example, approximately 1.0 to 1.5 mm. The outer surface of this coating layer 14 is machined smoothly, thereby securing linear precision and precision of the cylindrical surface of the pipe member 11. Note that the coating layer 14 may be constituted by various synthetic resins other than the abovementioned synthetic resin (for example, an epoxy resin, acrylic resin, polyethylene or the like).

The synthetic resin friction coating layer 18 is for enhancing the friction between the paper and the paper feed roller 10, and is formed on an entire outer surface of the coating layer 14. This synthetic resin friction coating layer 18 is formed with an electrically conductive film (not shown) that is necessary for electrostatic powder coating a synthetic resin layer 17, and with the synthetic resin layer 17 containing the hard particles 16. The hard particle 16 contained in the synthetic resin friction coating layer 18 is alumina having a particle diameter of 60 to 150 μm; however, hard particles of various ceramics other than alumina, glass particles, diamond particles, hard abrasive grains and the like may apply. The synthetic resin layer 17 is preferably to have a film thickness that is approximately half the particle diameter of the hard particles, and is formed with a synthetic resin (for example, epoxy resin, acrylic resin or the like) having a film thickness of 40 to 75 μm.

A method of fabricating the paper feed roller 10 will now be described.

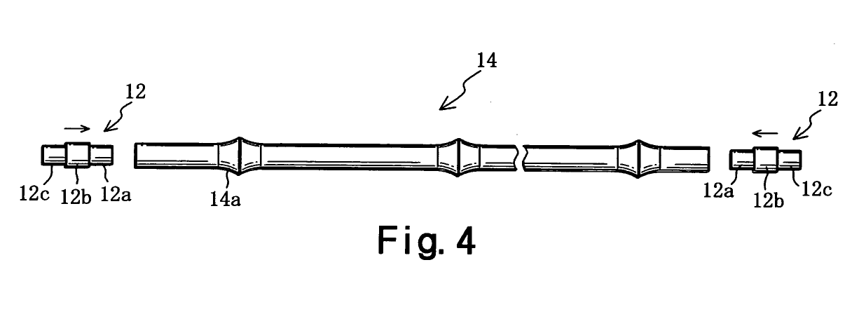

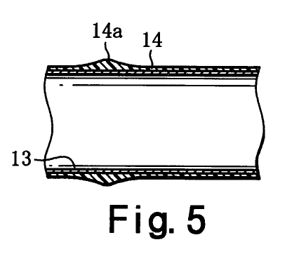

First of all, in the first step, the steel pipe 13 covered with the coating layer 14 made from the same type of synthetic resin is prepared as material for the hollow pipe member 11 forming the paper feed portion for feeding paper, as shown in FIG. 4 and FIG. 5. As to the material used, an artificial bamboo for gardening where it is cut to a desired length is put to use, thus the coating layer 14 also has a plurality of sections 14a. In parallel to this, the pair of shaft members 12 made of stainless steel to be fastened on to the both end portions of the pipe member 11 are prepared.

As shown in FIG. 4, the shaft member 12 is obtained by integrally forming an internal fitting portion 12a, large-diameter portion 12b, and shaft portion 12c, where the outer diameter of the internal fitting portion 12a is larger than the inner diameter of the steel pipe 13 by approximately 10 to 15 μm, and the outer diameter of the large-diameter portion 12b is substantially the same size as the outer diameter of a portion other than the section 14a in the coating layer 14.

Note that the thickness, length, and shape of the shaft portion 12c of the shaft member 12 are not limited to those shown in the drawings; sometimes gear teeth for externally fitting and fixing a gear member in a drive mechanism for rotating and driving the paper feed roller 10 are formed in the shaft portion 12c, or sometimes are formed in a shaft portion having a D-shaped section in order to fasten the gear or the like, thus the shaft portion 12c is formed in various thicknesses, lengths, and shapes in response to the drive mechanism of the paper feed roller 10. Furthermore, the pair of shaft members 12 do not necessarily have the same structure as the shaft portion 12c, and are formed to have a different thickness, length, and shape in accordance with the drive mechanism of the paper feed roller 10.

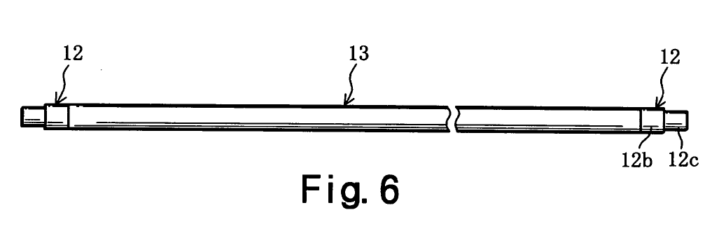

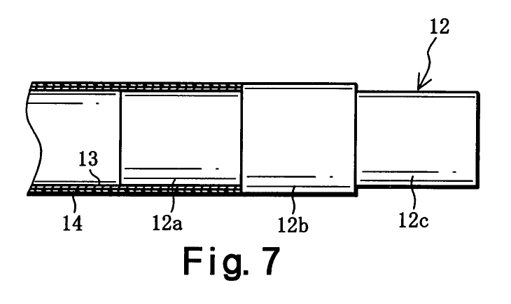

In the second step, the internal fitting portion 12a on each of the pair of shaft members 12 is press-fitted and fastened into the both end portions of the steel pipe 13 covered with the coating layer 14, and the large-diameter portion 12b is abutted on the end surface of the steel pipe 13, as shown in FIG. 6. Note that an adhesive may be applied for press-fitting, when press-fitting the internal fitting portion 12a.

Then, after removing the sections 14a of the coating layer 14 by means of machining (cutting), at least a part of the outer surfaces of the shaft members 12 (for example, the outer surface of the large-diameter portion 12b) and an entire outer surface of the coating layer 14 are machined (polished) smoothly. However, in order to enhance linear precision of the shaft member 12 and pipe member 11 and linear precision of the shaft center, the outer surface of the shaft portion 12c of the shaft member 12 too is preferably machined (polished) smoothly.

Thereafter, in the third step, the synthetic resin friction coating layer 18 containing the hard particles 16 is formed on the outer surface of the coating layer 14, as shown in FIG. 2. In this case, by applying an electrically conductive coating composition on the entire surface of the polished coating layer 14 to a predetermined film thickness and then drying it, an electrically conductive film having a predetermined film thickness is formed. Next, a surface of the electrically conductive film is applied with electrostatic powder coating of synthetic resin powder that contains the hard particles 16 having a particle diameter of, for example, 60 to 150 μm. The synthetic resin powder is burnt to form the synthetic resin layer 17 having a film thickness of, for example, 40 to 75 μm, and containing the hard particles 16, thereby forming the synthetic resin friction coating layer 18. Note that the elements of the particle diameter of 60 to 150 μm and the film thickness of 40 to 75 μm are merely an example and are not limited to this example.

The film thickness of the synthetic resin layer 17 and the particle diameter of the hard particles 16 are not particularly limited to the abovementioned numeric figures; however, in order to prevent the hard particles 16 from being covered by the synthetic resin layer 17, the film thickness of the synthetic resin layer 17 is preferably made approximately half the particle diameter of the hard particles 16.

By employing a UV curing resin as the synthetic resin powder containing the hard particles 16 on the surface of the electrically conductive film, after the electrostatic powder coating of the synthetic resin powder, it is possible to irradiate this synthetic resin powder with ultraviolet radiation to cure it.

An operation of the paper feed roller 10 will now be described.

The paper feed roller 10 comprises the hollow pipe member 11 forming the paper feed portion, and the pair of stainless steel shaft members 12 fastened concentrically on to the both end portions of this pipe member 11, where the pipe member 11 has the steel pipe 13, the synthetic resin coating layer 14 for covering the outer surface of the steel pipe 13, and the synthetic resin friction coating layer 18 containing the hard particles 16 formed on the outer surface of the coating layer 14.

Therefore, rigidity of the paper feed roller 10 can be secured mainly from the steel pipe 13, and a lightweight and inexpensive synthetic resin coated steel pipe (an artificial bamboo, for example) can be taken to fabricate the pipe member 11. By machining the outer surface of the coating layer 14 instead of the steel pipe 13, linear precision and precision of the cylindrical surface can be obtained, thus the machining cost can be reduced. Since the steel pipe 13 is covered with the coating layer 14 and is thus rustproofed, rustproofing process such as plating, coating or the like can be omitted. Further, since the shaft members 12 are fastened on to the both end portions of the paper feed roller 10, the wall thickness of the steel pipe 13 can be reduced to a minimum. Consequently, the paper feed roller 10, which can be fabricated inexpensively, is lightweight, can secure rigidity, and has an excellent linear precision and precision of the cylindrical surface, is obtained.

After fastened the shaft members 12 to the both end portions of the steel pipe 13 covered with the coating layer 14, at least a part of the outer surfaces of shaft members 12 and the entire outer surface of the coating layer 14 are machined smoothly to thereafter form the synthetic resin friction coating layer 18 containing the hard particles 16 on the outer surface of the coating layer 14, thus linear precision and precision of the cylindrical surface of the outer surface of the paper feed roller 10 can be secured. Therefore the paper feed roller 10 which can feed paper smoothly and precisely can be fabricated, and also the paper feed roller 10 which can feed paper without causing the paper to slip due to the friction coating layer 18 can be fabricated.

A modified embodiment where the above-described embodiment is partially modified will now be described.

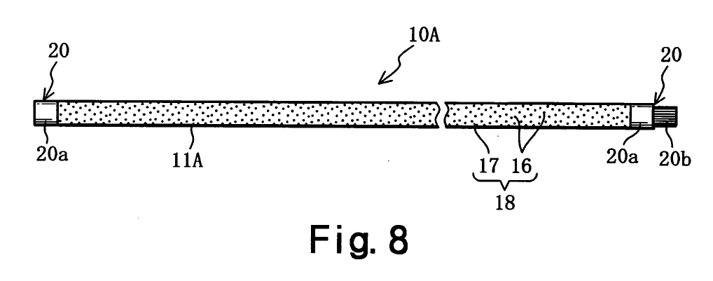

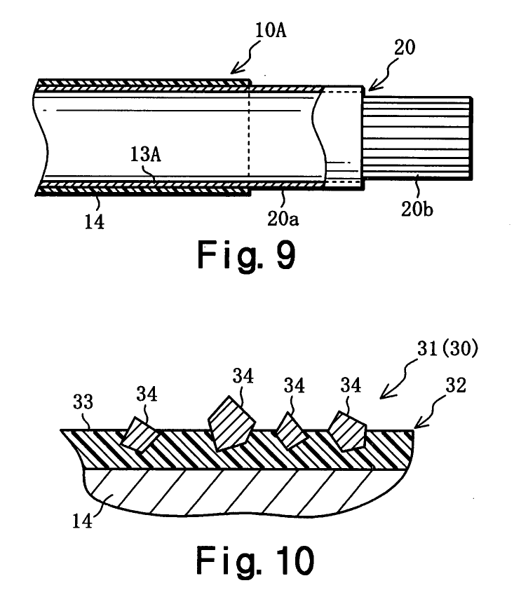

Explanation will be omitted by denoting the components, which are similar to those of the above-described embodiments, with the same or similar numerals. As shown in FIG. 8 and FIG. 9, in a paper feed roller 10A the shaft members 12, 12 are omitted, a pipe member 11A is extended to both sides so as to be longer than the paper feed portion, and shaft-like portions 20 consisting of a steel pipe 13A are formed integrally in both end portions of the pipe member 11A. In the shaft-like portions 20, the coating layer 14 for covering the steel pipe 13A is removed. The friction coating layer 18 formed on the coating layer 14, hard particles 16, and synthetic resin layer 17 is same as that of the above-described embodiment.

At least a shaft portion 20a is formed in each shaft-like portion 20, the shaft portion 20a being to be supported rotatably at the bearing member of the printer. Gear teeth 20b (gear teeth for externally fitting and fixing a gear member in a drive mechanism for rotating and driving the paper feed roller 10A) that extend outward in the axial direction from the shaft portion 20a are integrally formed on one of the shaft-like portion 20 through a forming process. Only the shaft portion 20a is formed on the other shaft-like portion 20. In this manner, as long as the pair of shaft-like portions 20 are formed by utilizing the steel pipe 13A, a steel pipe having a wall thickness of, for example, approximately 0.4 to 1.0 mm is employed for the steel pipe 13A. Note that the structure of the shaft-like portions 20 is not limited to what is shown in the figures, and is configured is various structures as with the abovementioned shaft member 12 in the context of the drive mechanism for rotating and driving the paper feed roller 10A. In this way, since the shaft-like portions 20 are configured by effectively utilizing the steel pipe 13A, the number of parts without the shaft members 12 of the above-described embodiment can be further reduced, and the fabrication cost can be reduced even more.

Next, the additional embodiment will be described.

A paper feed roller 30 of another embodiment is obtained by modifying the synthetic resin friction coating layer 18 in the feed roller 10 of the above-described embodiment. Note that explanation is omitted by denoting the components, which are same as those in the case of the paper feed roller 10, with the same numerals.

As shown in FIG. 10, in the paper feed roller 30, a synthetic resin friction coating layer 32 of a pipe member 31 is formed on the entire outer surface of the coating layer 14. This synthetic resin friction coating layer 32 has a UV curing type adhesive 33 applied and fixed to the outer surface of the coating layer 14, and a large number of hard particles 34 that are dispersed in and substantially evenly adhered and fixed to the UV curing type adhesive 33.

The film thickness of the UV curing type adhesive 33 applied to the outer surface of the coating layer 14 is 30 to 35 μm, and the hard particle 34 fixed to the UV curing type adhesive 33 is alumina having a particle diameter of 30 to 60 μm, which is same as or somewhat larger than the film thickness of the UV curing type adhesive 33.

As to the UV curing type adhesive 33, an acrylic adhesive, polyurethane adhesive, silicon adhesive, or epoxy adhesive of UV curing type is put to use. Furthermore, for the hard particles 34, hard particles of various ceramics other than alumina (such as silicon carbide or zirconia), metallic particles of high hardness, metallic oxide particles, glass particles, diamond particles, hard abrasive grains and the like may apply.

In the synthetic resin friction coating layer 32, a large number of hard particles 34 are securely fixed to the UV curing type adhesive 33 and relatively significantly exposed to the surface side of the UV curing type adhesive 34. Therefore, the friction coefficient μ (for example, μ=1.1) of the synthetic resin friction coating layer 32 dramatically becomes large, thereby improving paper feed performance of the paper feed roller 30.

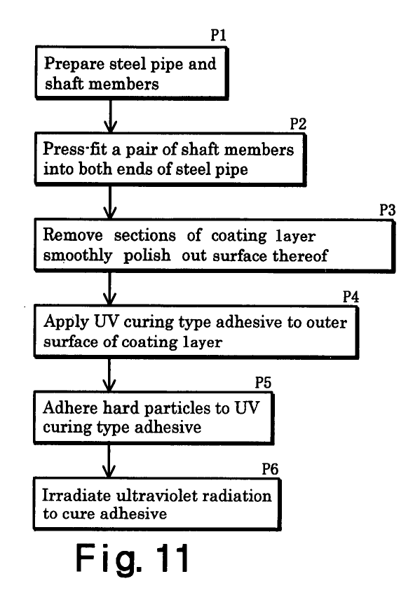

A method of fabricating the paper feed roller 30 will now be described with reference to FIG. 11. Here, Pi (where i=any of 1 to 6) in the process drawing FIG. 11 indicates each step.

First, in P1 (preparation step), the steel pipe 13 covered with the synthetic resin coating layer 14 is prepared as material for the hollow pipe member 31 forming the paper feed portion for feeding paper, and the pair of shaft members 12 to be fastened on to the both end portions of the pipe member 31 are prepared. As to the material used for this preparation, an artificial bamboo for gardening is cut to a desired length, to be used, thus the coating layer 14 has the plurality of sections 14a.

Secondly, in P2, the pair of shaft members 12 are press-fitted and fastened into the both end portions of the steel pipe 13 covered with the coating layer 14, and then, in P3 (machining step), the sections 14a of the coating layer 14 are removed by means of machining (cutting), after which at least a part of the outer surfaces of the shaft members 12 and the entire outer surface of the coating layer 14 are machined (polished) smoothly. In this case, these surfaces are subjected to machining by a polishing machine by supporting the pair of shaft members 12 and rotating the steel pipe 13. Note that the P1 to P3 described above are the same as the steps in the case of fabricating the paper feed roller 10 of the above-described embodiment.

Next, in P4 (adhesive application step), the UV curing type adhesive 33 is applied to the smoothed outer surface of the coating layer 14. In this step, a spin-coating technique is used to put a predetermined number of drops of the UV curing type adhesive 33 into the coating layer 14, and thereafter the steel pipe 13 (coating layer 14) is rotated, for example, around the shaft at high speed to obtain the state where the UV curing type adhesive 33 is substantially evenly applied to the outer surface of the coating layer 14, and to form a film having a film thickness of 30 to 65 μm. Note that a brush or roller may be used to apply the UV curing type adhesive 33 to the outer surface of the coating layer 14.

In this P4 (adhesive application step), prescribed recovery equipment (not shown) is used for recovering unapplied UV curing type adhesive 33 out of the UV curing type adhesive 33 that is used to be applied to the outer surface of the coating layer 14, and for reusing the recovered UV curing type adhesive 33. Hence, the waste of the UV curing type adhesive 33 can be eliminated, which contributes to cost reduction of the fabrication of the feed roller 30.

Next, in P5 (particle adhering step), a large number of hard particles 34 are dispersed in and substantially evenly adhered to the UV curing type adhesive 33 that has been applied to the outer surface of the coating layer 14 but has not yet set, so as to obtain the desired density. Specifically, particle spray equipment (not shown) is used to spray onto the UV curing type adhesive 33 by mixing a large number of hard particles 34 with the air coming out of the mouth of the equipment. In this case, the steel pipe 13 is rotated around the shaft with respect to the abovementioned mouth, and, if necessary, is moved relatively in the axial direction to spray a large number of hard particles 34 onto the UV curing type adhesive 33.

In this P5 (particle adhering step), prescribed recovery equipment (not shown) is used for recovering hard particles 34 that are not adhered to the UV curing type adhesive 33 out of the hard particles 34 that had been sprayed by means of the particle spray equipment, and for reusing the recovered hard particles. Hence, the waste of the hard particles can be eliminated, which contributes to cost reduction of the fabrication of the feed roller 30.

Note that P4 (adhesive application step) and P5 (particle adhering step) are performed in a condition where ultraviolet radiation is not irradiated, in order to prevent the UV curing type adhesive 33 from curing.

Next, in P6 (adhesive curing step), UV irradiation equipment (not shown) is used to apply ultraviolet radiation to the UV curing type adhesive 33 having a large number of hard particles 34 adhered thereto to cure the UV curing type adhesive 33, thereby forming, on the outer surface of the coating layer 14, the synthetic resin friction coating layer 32 containing a large number of hard particles 34.

An operation and effect of the fabrication method of the paper feed roller 30 will now be described.

After applying the UV curing type adhesive 33 to the outer surface of the coating layer 14 coated on the steel pipe 13, a large number of hard particles 34 are easily and securely dispersed in and substantially evenly adhered to this UV curing type adhesive 33. Consequently, as shown in FIG. 10, while the UV curing type adhesive 33 appropriately contains a large number of hard particles 34, the hard particles 34 are caused to be exposed to the surface side of the UV curing type adhesive 33 relatively significantly, in which state ultraviolet radiation is applied onto the UV curing type adhesive 33 to cure it, whereby a large number of hard particles 34 can be securely fixed to the UV curing type adhesive 33. Therefore, the friction coefficient μ (for example, μ=1.1) of the synthetic resin friction coating layer 32 containing the hard particles 34 dramatically becomes large, thereby improving paper feed performance of the paper feed roller 30.

Moreover, by irradiating the UV curing type adhesive 33 with ultraviolet radiation, the UV curing type adhesive 33 can be cured readily, thus the amount of time taken in P6 (adhesive curing step) can be shortened, and also efficiency of the fabrication of the paper feed roller 30 is increased. Since it is not necessary to raise the temperature of the steel pipe 13, coating layer 14 and the like in order to cure the UV curing type adhesive 30, heat deformation (thermal expansion) in the steel pipe 13, coating layer 14 and the like can be prevented to fabricate the paper feed roller 30 precisely.

Further, when applying the UV curing type adhesive 33 to the outer surface of the coating layer 14, the UV curing type adhesive 33 that is not applied is recovered. Furthermore, when adhering the hard particles 34 to the UV curing type adhesive 33, the hard particles 34 that are not adhered to the UV curing type adhesive 33 are recovered. The recovered UV curing type adhesive 33 and hard particles 34 are to be reused, thus the wastes of these UV curing type adhesive 33 and hard particles 34 can be eliminated. Moreover, as with the fabrication method of the paper feed roller 10 of the above-described embodiment, an extremely inexpensive artificial bamboo for gardening, which has a structure where the steel pipe 13 is covered with the synthetic resin coating layer 14, can be employed as the material of the hollow pipe member 31 forming the paper feed portion for feeding paper, thus the fabrication cost of the paper feed roller 30 can be dramatically reduced. As the pipe member 31, a pipe that is fabricated by an inexpensive method for fabricating an artificial bamboo may be used, instead of using the one obtained by processing an artificial bamboo for gardening as described above. Consequently, as with the case where a commercially available artificial bamboo is used, the fabrication cost of the paper feed roller 30 can be dramatically reduced.

In this additional embodiment, before press-fitting the pair of shaft members 12 into the both end portions of the steel pipe 13, the steps of P3, P4, P5, and further P6 may be executed, and thereafter the pair of shaft members 12 may be press-fitted into the both end portions of the steel pipe 13. Further, the step of smoothly machining at least a part of the outer surfaces of the shaft members 12 fastened on to the steel pipe 13 can be omitted.

Note that the present invention is not limited to the embodiments described above. According to those skilled in the art, the present invention can be put into practice by making various changes to the above-described embodiments without departing from the scope of the invention, and is to include these modified embodiments.

### INDUSTRIAL APPLICABILITY

The paper feed roller and the fabrication method thereof of the present invention can be applied to a paper feed roller and a fabrication method thereof in, not only a printer, but also in various office automation equipment or business equipment, such as a facsimile device, copier, printing machine, drawing plotter and the like.

1. A paper feed roller for feeding paper, comprising:
a hollow pipe member forming a paper feed portion for feeding paper, and a pair of shaft members fastened concentrically on to both end portions of the pipe member,
wherein said pipe member comprises a steel pipe, a coating layer made from a synthetic resin for covering an outer surface of the steel pipe, and a synthetic resin friction coating layer containing hard particles formed on an outer surface of the coating layer.

2. A paper feed roller for feeding paper, comprising:
a hollow pipe member forming a paper feed portion for feeding paper,
wherein said pipe member comprises a steel pipe, a coating layer made from a synthetic resin for covering an outer surface of the steel pipe, and a synthetic resin friction coating layer containing hard particles formed on an outer surface of the coating layer.

3. A paper feed roller according to claim 1 or 2, wherein the outer surface of said coating layer is machined smoothly, after which said synthetic resin friction coating layer is formed on the outer surface of the coating layer.

4. A paper feed roller according to claim 3, wherein said pipe member is fabricated using a steel pipe coated with said coating layer as material.

5. A method of fabricating a paper feed roller for feeding paper, comprising:
a first step in which a steel pipe covered with a synthetic resin coating layer is prepared as material for a hollow pipe member forming a paper feed portion for feeding paper, and a pair of shaft members to be fastened on to both end portions of the pipe member are prepared;
a second step in which the pair of shaft members are fastened on to the both end portions of the steel pipe covered with said coating layer, and then at least a part of outer surfaces of said shaft members and an entire outer surface of said coating layer are machined smoothly; and
a third step in which a synthetic resin friction coating layer containing hard particles is formed on the outer surface of said coating layer.

6. A method of fabricating a paper feed roller for feeding paper, comprising:
a preparation step in which a steel pipe covered with a synthetic resin coating layer is prepared as material for a hollow pipe member forming a paper feed portion for feeding paper;
a machining step in which an entire outer surface of said coating layer is machined smoothly;
an adhesive application step for applying a UV curing type adhesive on the outer surface of said coating layer;
a particle adhering step in which a large number of hard particles are dispersed in and adhered substantially evenly to the UV curing type adhesive adhered to the outer surface of said coating layer; and
an adhesive curing step in which ultraviolet radiation is applied to the UV curing type adhesive having said hard particles adhered thereto to cure the UV curing type adhesive, and to form a synthetic resin friction coating layer containing the hard particles on the outer surface of said coating layer.

7. The method of fabricating a paper feed roller according to claim 6, wherein a pair of shaft members to be fastened to both end portions of said pipe member are prepared in said preparation step, and after fastening the pair of shaft members on to the both end portions of said steel pipe, the entire outer surface of said coating layer is machined in said machining step.

8. The method of fabricating a paper feed roller according to claim 7, wherein at least a part of outer surfaces of the shaft members fastened on to said steel pipe is machined smoothly in said machining step.
